(19) United States
(12) Patent Application Publication
(10) Pub. No.: US 2009/0033736 A1
(43) Pub. Date: Feb. 5, 2009

(54) Wireless Video Audio Data Remote System

(76) Inventor: John THOMASON, Denton, TX (US)

Correspondence Address: STORM LLP, BANK OF AMERICA PLAZA, 901 MAIN STREET, SUITE 7100, DALLAS, TX, 75202, US

(21) Appl. No.: 12/181,931

(22) Filed: Jul. 29, 2008

Related U.S. Application Data
(60) Provisional application No. 60/953,433, filed on Aug. 1, 2007.

(51) Int. Cl. H04N 7/14

(52) U.S. Cl. 348/14.02; 348/E07.077

(57) ABSTRACT

A method and system for remote assistance and review of a technician or multiple technicians, in real time, working with equipment of various complexities. A technician or multiple technicians at a remote location are coupled by a wireless means to an advisor at a local station so that the advisor may view and hear the same stimuli as the technician, and that the advisor and technician may communicate. Additionally a technician or multiple technicians may also be coupled by a wireless means to one or more non-technical observers at a separate local station so that they can view and hear the same stimuli as the advisor. The technician has limited training or otherwise in need of support, and may be a field engineer, technician or maintenance personnel. The advisor has extensive training and is able to provide technical support, generally has extended and specialized knowledge with regard to the remote apparatus, and may be a technical expert on the remote apparatus. The technician may comprise an individual or a group with technical training and knowledge, but lacking managerial or other authority, while the advisor comprises an individual or a group with such authority. The technician communicates with the advisor by visual cues or ordinary speech, while the advisor views and listens to the remote apparatus. The advisor gives advice to the technician for manipulating or repairing the remote apparatus. Alternatively, an intermediate advisor may advise the technician and be advised by a higher-level advisor.

### CROSS-REFERENCE TO RELATED APPLICATION

This application claims priority to U.S. Provisional Patent Application No. 60/953,433, entitled “WIRELESS VIDEO AUDIO DATA REMOTE SYSTEM,” filed on behalf of inventor John Thomason, which is hereby incorporated by reference for all purposes.

### TECHNICAL FIELD

This invention relates to a wireless video audio data remote system.

### BACKGROUND

The nature of business organizations and their employees is generally such that, in most any subject, there are a relatively small number of persons with extensive training and experience (e.g., “experts”) and a relatively large number of persons with only limited training and experience (e.g., technicians). This problem is exacerbated by the relatively larger costs associated with the former. Accordingly, when a business organization seeks to apply a person's skills to a problem, it is often faced with the fact that persons with the extensive training and skill are a scarce resource.

With many problems, and in particular with the problem of servicing and trouble-shooting equipment, experience shows that most tasks require only a subset of the full experience that characterizes experts in the field, and that those tasks can be adequately carried out by entry-level technicians. However, when a technician is confronted with a task requiring an expert, often the only indicator thereof is the technician's inability to solve the problem. Sometimes the technician's lack of extensive knowledge can actually make the problem worse. These effects serve to increase the cost, time, effort, and frustration associated with servicing and troubleshooting equipment. Additionally, it is often desirous for non-technical observers to simultaneously view these tasks being performed but they may be unable to be at the location while the tasks are ongoing. Additionally, it would be desirous to provide multiple angles of view for both the expert and the non-technical observers while interacting with the field technician.

One method in the prior art has been to advise technicians at a fixed location using audio, video and data transmission over various wired networks. An example of this is U.S. Pat. No. 5,619,183 (Ziegra et al.). The main disadvantage of that fixed-site system is that remote-site technician oversight is impractical when a mobile work force requires video, audio and data transmission from continually changing job site locations. Another disadvantage is that the fixed-site to fixed-site system software does not fully utilize the idea of “leveraged expertise” wherein the expertise of one or more experts can be made accessible in real-time by one or more remotely located mobile technicians, thus multiplying or “leveraging” the available expertise.

Another method in the prior art has been to advise technicians at continually changing job site locations using wireless networks. An example of this is U.S. Pat. No. 6,690,273 B2 (Thomason). The main disadvantage of that wireless system is that it utilizes a wearable processor and camera that does not allow for independent control of the camera's pan, tilt and zoom controls, a laser pointer for directional assistance and lacks software that allows non-technical observers and technical advisors a means to remotely control the camera's pan, tilt and zoom controls. Additionally, that wireless system lacks a means to view multiple wireless camera feeds from the job site that could assist the expert and the non-technical observer from interacting efficiently with the field technician. The overall result of these deficiencies is a reduced “shared perspective,” the lack of which hampers the remote guidance experience when both individuals need to rapidly understand what item(s) in the remote view are being discussed.

Accordingly, it would be advantageous to provide a method and system by which technicians can perform their assigned tasks, in a wireless environment, while allowing experts to assist them when expert assistance is required. Additionally, it would be advantageous to provide a method and system by which non-technical observers can watch remote tasks as they are being performed by the technicians, enable perusal of the general work area and increase the shared perspective required to perform those tasks, in a wireless environment. Additionally, it would be advantageous to provide a method and system by which experts can control the wireless camera's pan, tilt and zoom controls, activate the camera mounted laser pointer for directional guidance and grant that capability to non-technical observers should it be desirous to do so. Additionally, it would be advantageous to provide a method and system by which experts and non-technical observers can view multiple job site wireless camera signals with or without the need to interact with the field technicians.

### SUMMARY

The invention provides a method and system for remote assistance and review of a technician or group of technicians working with equipment of various complexities. Additionally, the invention provides a method and system for observation of a technician or group of technicians by non-technical observers. In accordance with a preferred embodiment of the present invention, a technician at a remote job site is coupled to an advisor manning a local station (where “local” and “remote” are relative to a remote apparatus being controlled or serviced by the technician, and do not necessarily denote large distance) in such a manner that the advisor may view and hear the same stimuli as the technician and that the advisor and technician can communicate.

Additionally, the invention provides a method and system for observation of a technician or group of technicians by non-technical observers. In accordance with a preferred embodiment of the present invention, a technician at a remote job site is coupled to a non-technical observer manning a local station (where “local” and “remote” are relative to a remote apparatus being controlled or serviced by the technician, and do not necessarily denote large distance) in such a manner that the non-technical observer may view and hear the same stimuli as the technician and that the observer and technician can communicate.

In accordance with a preferred embodiment of the present invention, a technician at a remote job site may be coupled by a wireless communication link(s) to a local station. The technician at the remote job site is located near an apparatus consisting of a video and audio sensor, such as a camera and a microphone, and a receiver for the communication link, such as earphone or speaker, and a wireless portable data processor. In accordance with a preferred embodiment of the present invention, the wireless portable data processor may consist of a remotely controllable wireless camera with an embedded web server, pan, tilt and zoom mechanisms, a camera mounted laser pointer for directional guidance, full duplex two way audio capability and an audio amplifier, speaker(s) and volume control to allow verbal communication.

In accordance with an alternative embodiment of the present invention, the wireless portable processor would include an audible or visual communication request indicator that could be heard or seen by the field technician at a distance. In accordance with an alternative embodiment of the present invention, the wireless portable processor would contain a Bluetooth audio communication capability to allow hands free, full duplex audio communication between the advisor at the local station and the field technician. The communication link comprises a wireless communication path to/from the local station, and may further comprise data encoding, compression, and error correction/detection devices. In accordance with a preferred embodiment of the present invention, the communication link may consist of a wireless mobile router coupled with a WAN (wide area network data card) to allow a wireless connection to the Internet and the local station. In accordance with an alternative embodiment of the present invention, the field technician would couple other wired or wireless devices such as handheld and wearable PCs (Personal Computers), credit card readers, barcode readers, meters, alarms and telemetry devices to the Internet via the wireless mobile router and WAN wireless modem contained in the wireless portable processor.

In accordance with an alternative embodiment of the present invention, the wireless portable processor would wirelessly relay telemetry and diagnostic data from a wireless interface attached to the device or equipment being serviced or repaired. In accordance with an alternative embodiment of the present invention, the wireless portable processor would contain a GPS location capability. In accordance with an alternative embodiment of the present invention, the wireless camera would be embedded with a chip set that allows for direct coupling to the WAN (wide area network) and the Internet without the need of a wireless mobile router or other external coupling device. In accordance with an alternative embodiment of the present invention, the wireless portable processor may consist of a wearable or handheld PC with an attached camera and combination headphone/microphone for full duplex audio communication via ordinary speech.

In accordance with an alternative embodiment of the present invention, the wearable or handheld PC would be separated from the wearer or holder and mounted on a support device such as a tripod and contain both digital and mechanical pan, tilt and zoom capability to allow observation of the field technicians, remote manipulation capability of the wireless camera's pan, tilt and zoom mechanisms and the observation of the general work area without requiring interaction with the field technician.

In accordance with an alternative embodiment of the present invention, the wireless portable processor may consist of a wireless cell phone affixed with a real-time two way video transmission capability, full duplex audio capability, a web browser and a codec for video data processing. In accordance with an alternative embodiment of the present invention, the video enabled cell phone would be separated from the remote technician and mounted on a support device such as a tripod and contain both digital and mechanical pan, tilt and zoom capability to allow observation of the field technician(s), remote manipulation capability of the camera mechanisms and the observation of the general work area without requiring ongoing interaction with the field technician to change the camera's viewed area.

The local station comprises a PC, video and audio display, such as a monitor, a speaker or headphones, a microphone, software that allows for real-time communication to multiple technicians, software camera controls that allow for remote pan, tilt and zoom camera manipulation and a two way, full duplex audio communication system for the communication link with the remote job site, a software means to permit other interested individuals to watch the video and listen to the audio for forwarding username & password access, motion detection and recording capability and a software enabled audible or visible communication request capability.

In accordance with an alternative embodiment of the present invention, the local station remote camera control software would automatically or with manual control enable the forwarding of e-mail alerts that could include snapshots or video to authorized individuals. In accordance with an alternative embodiment of the present invention, the local station may comprise an Internet coupled television set to allow viewing of the video/audio/data transmitted from the wireless portable processor.

In accordance with an alternative embodiment of the present invention, the local station may be a mobile device such as an Internet coupled wireless wearable PC with embedded web browser, an Internet coupled wireless cell phone with embedded web browser, an Internet coupled handheld PC with embedded web browser or any mobile device capable of viewing the video and receiving the audio and controlling the wireless camera's pan, tilt and zoom controls.

In accordance with an alternative embodiment of the present invention, the local station may consist of any device capable of viewing the video and receiving the audio without necessarily having the capability of remotely manipulating the wireless camera's pan, tilt, and zoom controls.

In accordance with a preferred embodiment of the present invention, the technician may comprise an individual or a group with limited training or otherwise in need of support, such as a field engineer or technician. The technician(s) should generally know how to operate the remote job site apparatus, but need not have extended or specialized knowledge with regard thereto. The advisor may comprise an individual or a group with extensive training and able to provide technical support, who generally does have extended and specialized knowledge with regard to the remote job site apparatus, such as a technical expert on the remote job site apparatus.

In accordance with an alternative embodiment of the present invention, the technician(s) may comprise an individual or a group with technical training and knowledge, but lacking managerial or other authority, while the advisor(s) are an individual or a group with such authority. In accordance with an alternative embodiment of the present invention, the advisor may comprise an individual or a group of non-technical observers who have no specialized training but who desire to observe the activities of the technician(s) from a remote location without interaction with the technician(s).

In accordance with a preferred embodiment of the present invention, the technician(s) couples the remote job site communication apparatus to the wireless communication link(s) and to the local station communication apparatus. Alternatively, the advisor(s) may initiate the connection to the wireless job site communication apparatus by coupling the local station to the Internet, via a web browser and the wireless communication link, by entering an Internet address (URL) specific to a wireless camera(s) coupled with the wireless portable processor. The technician(s) may communicate with the advisor(s) by visual cues or ordinary speech, while the advisor(s) may view and listen to the audio and video data being transmitted from the remote job site apparatus. The advisor(s) may give advice to the field technician for manipulating the remote job site apparatus, and may manipulate the remote job site apparatus directly by means of the control signal or data signal feeds. Thus, the technician(s) may service/repair/operate the remote job site apparatus as if the advisor were peeking over his shoulder or alternately viewing the technician(s) and general work area from a further distance.

In accordance with an alternative embodiment of the present invention, an intermediate advisor may advise/control the technician(s) and be advised/controlled by a higher-level advisor.

In accordance with an alternative embodiment of the present invention, an advisor may control the remote job site communication apparatus by manipulating the wireless camera's pan, tilt and zoom mechanisms and the camera mounted laser pointer by utilizing software based camera controls within the local processor without the need of interacting or advising the remotely located technician.

In accordance with an alternative embodiment of the present invention, the field technician(s) may manipulate the remote wireless camera(s) mechanisms without interaction with the local station via a mobile PC or cell phone and record video, still images and other data for future reference or forwarding to other interested individuals.

In accordance with an alternative embodiment of the present invention, the field technician(s) may forward the video/audio and data to other field technicians for purposes of consultation without the need to interact with the advisor at the local station.

In accordance with an alternative embodiment of the present invention, the field technician(s) may forward the video/audio and data to non-technical observer(s) without interacting with the advisor at the local station.

In accordance with an alternative embodiment of the present invention, the local station advisor(s), the field technician(s) and the non-technical observer(s) could forward the video/audio/data from the wireless remote processor(s) to Federal Government agencies, military, emergency first responders, law enforcement and local/national news providers by forwarding username and password access.

In accordance with an alternative embodiment of the present invention, the field technician(s) may not be technicians at all but may be military, law enforcement, emergency first responders, Federal Government officials or any others who may be required to share real-time audio/video/data with others.

In accordance with an alternative embodiment of the present invention, an advisor may grant permission to a non-technical observer to view the remotely located technician(s) by requiring a username and password in order to gain access to the remotely located wireless camera(s) pan, tilt and zoom controls, and the camera mounted laser pointer without the need of interacting or advising the remotely located technician(s).

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 shows a block diagram of a wireless remote system;

FIG. 2 shows a block diagram of a wireless portable communication apparatus for a remote system;

FIG. 3 shows a block diagram of a wireless portable camera with two way audio capability and pan, tilt and zoom controls;

FIG. 4 shows a block diagram of a local station for a wireless remote system;

FIG. 5 shows a block diagram of a centralized expertise station coupled to multiple wireless portable remote systems;

FIG. 6 shows a block diagram of a vehicular-based portable processor for a remote system; and

FIG. 7 shows a flow diagram of a method for operating a wireless remote system.

### DETAILED DESCRIPTION

In the discussion of the FIGURES, the same reference numerals will be used throughout to refer to the same or similar components.

### General Features of the Method and System

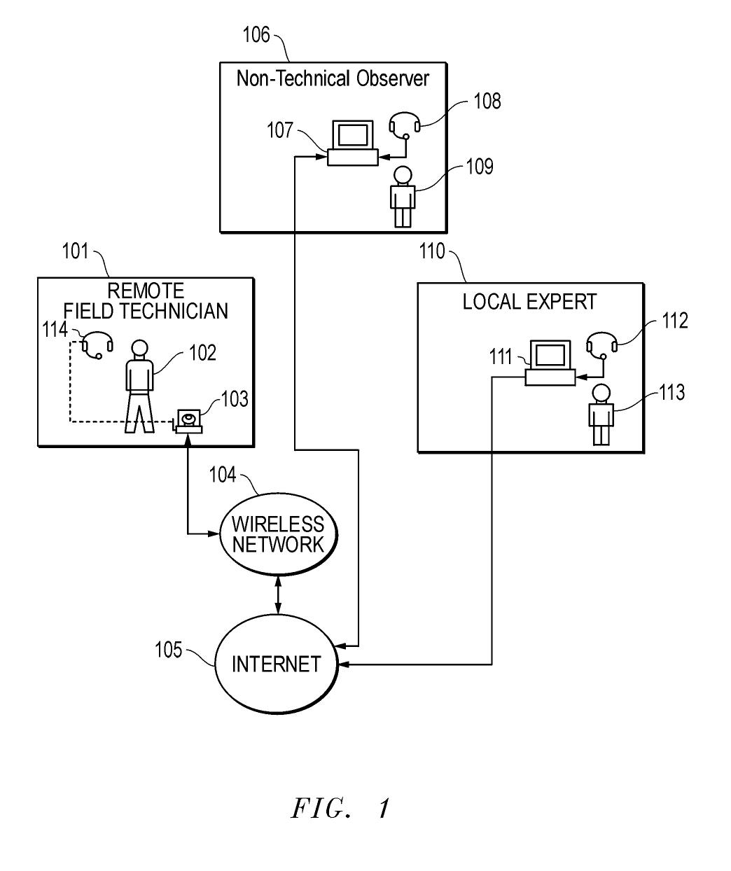

FIG. 1 shows a block diagram of a wireless remote system. A wireless remote system 101 comprises a mobile field technician 102 at a remote job site utilizing a wireless portable processor 103 and a wireless audio headphone/microphone 114 coupled by a wireless network 104 to the Internet 105 and coupled to the local station 110 and being advised by the local expert 113. The local station 110 is comprised of a local processor 111 and the local master technician audio/microphone headset 112 utilized by the local expert 113.

As described herein, the mobile field technician 102 may install/operate/service/maintain an apparatus at a remote job site with the advice and control of the local expert 113. The local expert 113 may view and hear the same stimuli at the remote site as the mobile field technician 102 by means of audio and video sensors at the remote job site. The mobile field technician 102 may communicate with the local master technician 113 by means of the wireless network 104. The mobile field technician 102 may communicate with the local expert 113 by means of the wireless network 104 and/or by means of the Internet 105.

The expert 113 may relay the audio and video signals from the mobile field technician 102 to be heard and viewed at a non-technical observer station 106, which comprises an ordinary computer 107, a headphone/microphone 108, and an Internet connection 105, and grant permission for the non-technical observer 109 to remotely manipulate the pan, tilt and zoom controls of the wireless portable processor's camera 103 by forwarding a username and password access.

As used herein, “local” and “remote” are relative to logical control of the remote job site apparatus and do not necessarily denote large distance. For example, the remote job site and the local station 108 may be located in the same building or even in the same room, where it is desired to logically separate the function of the mobile field technician 102 and the local expert 113, as in a local training environment. Similarly, the mobile field technician 102 need not be physically co-located with the remote job site apparatus where it is desired to control that remote job site apparatus by means of physically distant tools and software.

In accordance with a preferred embodiment of the present invention, remote air conditioning system control software, such as a Parker Controls VVT system, would allow a mobile field technician 102 to make adjustments to a facility's HVAC system with guidance from the local expert 113, without either of them physically being at the job site.

### Remote Wireless System Components

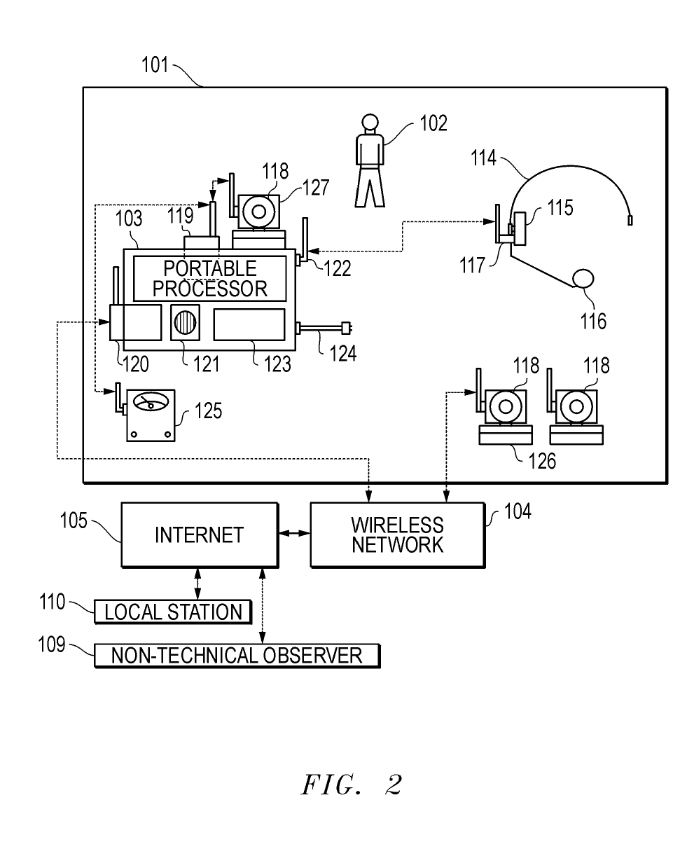

FIG. 2 shows a block diagram of the portable components of the wireless remote system.

The mobile field technician 102 wears or works near a group of components that comprise a wireless remote system 101. The wireless remote system 101 is comprised of a wireless portable processor 103, an earphone headset 114, a microphone 116, a wireless headset transceiver 117, and a portable wireless video sensor/camera 118, coupled with a laser pointer 127, for directional guidance. In accordance with a preferred embodiment of the present invention, the wireless portable processor 103 is of sufficient size and weight to be carried by the mobile field technician 102 and contains a wireless mobile router 119, that allows for wireless connections to multiple portable wireless video sensor/camera(s) 118, a wireless WAN data card 120, to allow for wireless connection to the wireless wide area network 104 and the Internet 105, a speaker 121, as an alternative means to hear communications from the local station 110, a battery 123, for portable operation of the wireless portable processor 103, a standard 110v plug/cord 124, for stationary power access, and a wireless transceiver 122, to allow communication with the wireless headset 114.

In accordance with a preferred embodiment of the present invention, the wireless earphone headset 114 comprises a set of headgear suitable for wearing by the mobile field technician 102, including the wireless earphones 115, preferably disposed near the mobile field technician's ears, and the microphone 116, is preferably disposed near the mobile field technician's mouth. Alternatively, the portable wireless video sensor/camera 118 may be detached from the wireless portable processor 103 and placed at a distance from the mobile field technician 102 in such a manner as to provide the local expert 113 a larger field of view while mounted to a stationary or motorized platform that allows for remote control of the pan, tilt, and zoom mechanisms of the portable wireless video sensor/camera 118.

Alternatively, there may be multiple portable wireless sensor/cameras 118 that could be wirelessly coupled to the wireless portable processor 103 by the wireless mobile router 119, which connects to the wide area wireless network 104 and the Internet 105, and provides a larger field of view to the local expert 113. Alternatively, there may be multiple portable wireless sensor/cameras 118 that could be wirelessly coupled to the wireless portable processor 103 by the wireless mobile router 119, which connects to the wide area wireless network 104, when coupled with the wide area wireless network card 120, and the Internet 105, and provides a larger field of view to a non-technical observer(s) 109.

In accordance with a preferred embodiment of the present invention, the wireless earphone headset 114 would comprise a microphone 116, for voice communication with the local expert 113, an earphone 115, for use on one ear by the mobile field technician 102, and a wireless transceiver 117, to couple with the wireless headphone transceiver 122. Alternatively, the mobile field technician 102 may not wear the wireless earphone headset at all, but would communicate with the local expert 113 by listening to verbal commands and ordinary speech via the portable processor speaker 121, and transmit audio to the local expert 113 via the camera mounted microphone 129.

Alternatively, the mobile field technician 102 may communicate by listening to verbal commands and ordinary speech from the local expert 113, via a speaker attached or embedded with the portable wireless video sensor/camera 118 and an adjustable volume control 128, and transmit audio to the local expert 113, via the camera mounted microphone 129.

In accordance with a preferred embodiment of the present invention, the wireless earphone headset 114 comprises the NCHSM-776 product by Specialty Products, Inc., P.O. Box 30665, Reno, Tex. 75462, and the GRT-1001 transceiver product by Polaris Industries, Inc., 470 Armour Drive, Atlanta Ga. The NCHSM-776 product is a combination earphone headset 114 and a noise canceling microphone 116. In accordance with an alternative embodiment of the present invention, the wireless earphone headset would have a jack for a wired connection to the wireless portable processor 103. In accordance with an alternative embodiment of the present invention, the combination earphone/microphone headset would have a Bluetooth wireless connectivity capability. In accordance with an alternative embodiment of the present invention, the wireless earphone headset 114 would be wirelessly coupled to a cellular phone and operate independently of the wireless portable processor 103.

In accordance with a preferred embodiment of the present invention, the portable wireless video sensor/camera(s) 118 would be detachable from the wireless portable processor 103, and would comprise a camera(s) 118, embedded with a wireless full duplex audio transceiver(s) and video transmitter(s) 130, and an embedded web server(s) and may contain a codec(s) for data compression and error correction. The wireless video transmitter(s) 130 would be wirelessly coupled to the wireless mobile router 119 and connected to the wide area wireless network 104, when coupled with the wide area wireless network data card 120, and to the Internet 105, which would provide multiple views to the local expert 113 and the non-technical observer 109.

In accordance with a preferred embodiment of the present invention, the wireless portable processor 103 would comprise the video/sensor camera 118, which would comprise the DCS-6620G Wireless G Internet Camera product by D-Link Inc., 17595 Mt. Herrmann, Fountain Valley, Calif. 92708, and a wireless mobile router 119, which would comprise the KR1 Mobile Router product by Kyocera Wireless Corp., 10300 Campus Point Dr., San Diego, Calif. 92121, and the wide area wireless network card 120, which would comprise the Merlin S720 wireless card product by Sprint Wireless, 2001 Edmond Halley Dr., Reston, Va. 20191.

In accordance with a preferred embodiment of the present invention, the camera 118 can be configured to alternatively provide high-resolution still images in place of continuous video images, represented by an analog or digital video signal in a standard format. In accordance with a preferred embodiment of the present invention, the camera 118 would be detachable from the wireless portable processor 103 and be functionally independent. In accordance with an alternative embodiment of the present invention, the wireless portable camera 118 would not require coupling to the wireless portable processor 103 and would connect directly to the wide area wireless network 104 via an embedded WAN 104 chipset, the Internet 105, and the local expert 113. Additionally, the wireless portable camera 118 would not require coupling to the wireless portable processor 103, and would connect directly to the wide area wireless network 104 via an embedded WAN 104 chipset, the Internet 105, and be viewed and controlled by a non-technical observer(s) 109 at the non-technical observer station 106.

### The Wireless Portable Camera

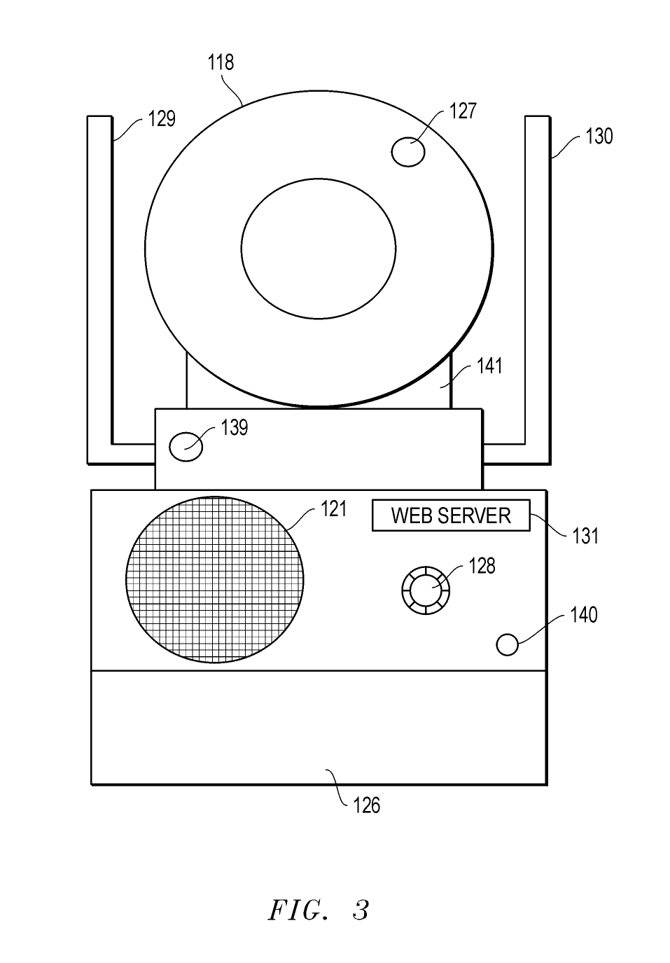

FIG. 3 shows a block diagram of a wireless portable camera 118 for a remote system. The wireless portable camera 118 comprises a wireless Internet capable camera with an embedded web server 131, headphone/microphone jack 140, pan, tilt and zoom mechanism 141, a laser pointer 127 for directional guidance, a wireless full duplex audio transceiver 129, a wireless video transmitter 130, a microphone 139, a speaker 121, a speaker volume control 128, and a rechargeable battery pack 126.

In accordance with a preferred embodiment of the present invention, the wireless portable camera 118 would be coupled by a wireless means to the wireless portable processor 103, the wireless mobile router 119, the wide area wireless network 104, the Internet 105, the local station 110, and the local expert 113. The local expert 113 would remotely operate the pan, tilt and zoom mechanisms 141 of the wireless portable camera 118 via local processor 111 camera control software and communicate via normal speech with the mobile field technician 102 via the speaker 121, and/or a wired or wireless headset/microphone 114.

In accordance with an alternative embodiment of the present invention, the wireless portable camera 118 would be coupled directly to the wide area wireless network (WAN) 104, the Internet 105, the local station 110, and the local expert 113, without the need to use the wireless portable processor 103. In accordance with an alternative embodiment of the present invention, the local expert 113 would grant permission to a non-technical observer 109, via a username and password requirement, to view the video/audio streaming from the wireless portable camera 118 and to remotely manipulate the wireless portable camera's pan, tilt and zoom mechanism 141 via software enabled camera controls operating with the local processor 111, to facilitate observing the activities of the mobile field technician 102 and the general work area. In accordance with an alternative embodiment of the present invention, the wireless portable camera(s) 118 would contain a visual or audible signal capability that notifies the mobile field technician of a desire to communicate, such as a flashing light or audible alarm. It would be clear to those skilled in the art that these alternative embodiments would be workable with the disclosed invention, without any undue experimentation.

In accordance with a preferred embodiment of the present invention, the camera would comprise the DCS-6620G Wireless G Internet Camera product by D-Link Inc., 17595 Mt. Herrmann, Fountain Valley, Calif. 92708.

### The Local Station

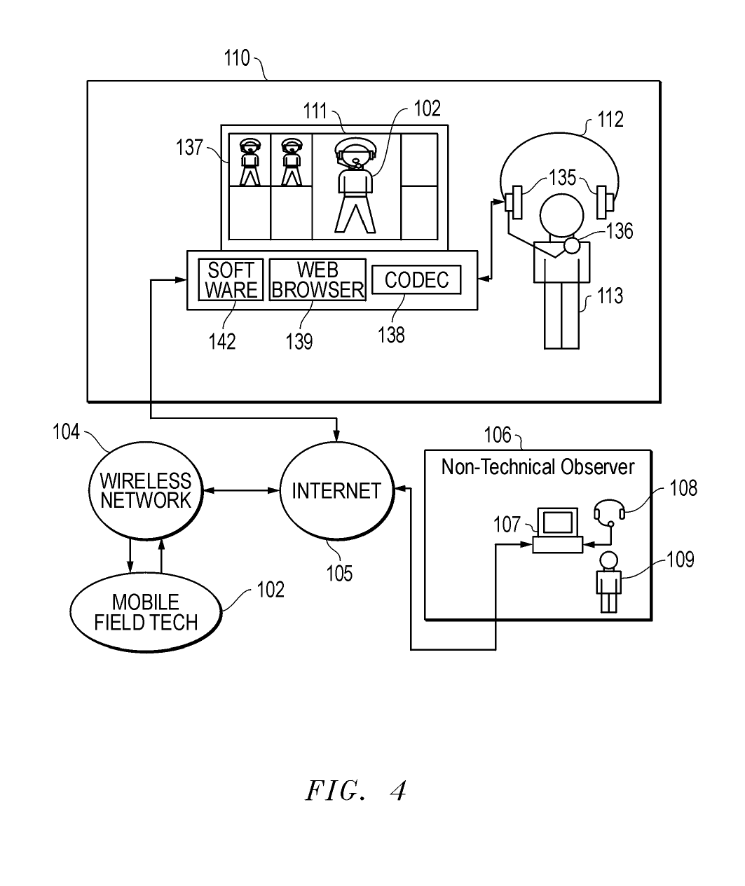

FIG. 4 shows a block diagram of a local station 110 for a remote system. The local station 110 comprises an operator headset 112, including earphones 135 and a microphone 136, a local processor 111, local station software 142, and a local expert 113.

In accordance with a preferred embodiment of the present invention, the local expert 113, would don the operator headset 112, and couple the local processor 111 to the Internet 105 via a web browser 139.

In accordance with a preferred embodiment of the present invention, the local station 111 would be coupled by a wireless means to the wireless portable processor 103 and the mobile field technician 102 via the wireless network 104 and/or the Internet 105.

In accordance with a preferred embodiment of the present invention, the local expert 113 would communicate with the mobile field technician 102 via normal speech and visual signals. The local expert 113 would view the visual signals from the mobile field technician's camera 118 on the video monitor of the local processor 111, hear the audio/speech from the mobile field technician 102 using the earphones 135 and give direction to the mobile field technician 102 via the microphone 136.

In accordance with a preferred embodiment of the present invention, the local processor 111 would comprise a computer of sufficient capacity to allow for a plurality of audio/video signals from a plurality of mobile field technicians 102 to be processed simultaneously. The local station software 142 would utilize a plurality of video windows that would contain the video signals from the individual mobile field technicians' cameras 118. When activated by the local expert 113, the individual reduced video windows 137 become enlarged video windows to facilitate observation of details.

Where appropriate, the local processor 111 may perform data compression, error detection and correction for audio and video signals transmitted from the mobile field technician 102, via the wireless portable processor 103. In accordance with an alternative embodiment of the present invention, the local processor 111 would comprise a two way audio/video enabled cell phone where the local expert 113 could monitor the activities and general work area of the mobile field technician 102 and manipulate the wireless remote camera(s) 118 pan, tilt and zoom mechanisms 141. In accordance with an alternative embodiment of the present invention, the local processor 111 would comprise a two way audio/video enabled handheld or wearable PC where the local expert 113 could monitor the activities and general work area of the mobile field technician 102 and manipulate the wireless remote camera(s) 118 pan, tilt and zoom mechanisms 141. Alternatively, the local processor 111 may be any mobile device capable of viewing the video stream and audio signal without necessarily providing the capability of manipulating the wireless remote camera(s) 118 pan, tilt and zoom mechanisms 141.

In accordance with a preferred embodiment of the present invention, the local expert 113 would grant permission to a non-technical observer 109 to view the activities of the mobile field technician 102 by forwarding a username and password requirement to gain access to the audio/video/data by listening to audio signals via a headset/microphone 108, and viewing the video signals via the non-technical observer local processor 107. In accordance with an alternative embodiment of the present invention, the non-technical observer local processor 107 would comprise a two way audio/video enabled cell phone where the non-technical observer 109 could monitor the activities and general work area of the mobile field technician 102 and manipulate the wireless remote camera(s) 118 pan, tilt and zoom mechanisms 141.

In accordance with an alternative embodiment of the present invention, the non-technical observer local processor 107 would comprise a two way audio/video enabled handheld or wearable PC where the non-technical observer 109 could monitor the activities and general work area of the mobile field technician 102 and manipulate the wireless remote camera(s) 118 pan, tilt and zoom mechanisms 141. Alternatively, the non-technical observer local processor 107 may be any mobile device capable of viewing the video stream and audio signal without necessarily providing the capability of manipulating the wireless remote camera(s) 118 pan, tilt and zoom mechanisms 141.

In accordance with an alternative embodiment of the present invention, the local station 110 is comprised of a local expert 113, utilizing a wireless portable processor 103 to communicate with one or more mobile field technicians 102. The term “local expert” is not to necessarily imply that the local expert 113 is constantly in a fixed location, but may himself/herself be mobile. Similarly, the term “mobile field technician” is not to necessarily imply that the mobile field technician is continually moving, but may himself/herself be at a fixed job site for a varying period of time. It would be clear to those skilled in the art that these alternative embodiments would be workable with the disclosed invention, without any undue experimentation.

In accordance with a preferred embodiment of the present invention, the local station software would comprise the D-ViewCam Management Software product by D-Link Inc., 17595 Mt. Herrmann, Fountain Valley, Calif. 92708.

In accordance with a preferred embodiment of the present invention, the local processor 111 would comprise the Pavilion a1110n product by Hewlett-Packard, Palo Alto, Calif.

In accordance with a preferred embodiment of the present invention, the local processor web browser 139 would comprise the Microsoft Internet Explorer product by Microsoft Inc., Redmond, Wash.

In accordance with a preferred embodiment of the present invention, the operator headset would comprise the SP-NCHSM-776 product by Specialty Products, P.O. Box 30665, Reno, Tex. 75462.

### The Wireless Network

The wireless network may comprise any wireless link capable of carrying sufficient information between the wireless portable processor 103 and the local processor 111, such as a CDPD cellular network, TDMA, CDMA, ARDIS, RAM, GSM, WI-MAX 802.11, 802.11b, 802.11g, spread spectrum RF, satellite, analog RF, laser and/or broad band microwave. In accordance with a preferred embodiment of the present invention, the wireless network 104 comprises the CDMA cellular wide area network coupled to the Internet 105. However, the wireless network 104 could be utilized as a direct communication link between the wireless portable processor 103 and the local processor 111, without using the Internet 105. It would be clear to those skilled in the art that these alternative wireless networks would be workable with the disclosed invention, without any undue experimentation.

In accordance with a preferred embodiment of the present invention, the camera 118 would comprise the DCS-6620G Wireless G Internet Camera product by D-Link Inc., 17595 Mt. Herrmann, Fountain Valley, Calif. 92708.

In accordance with a preferred embodiment of the present invention, the local processor 111 would comprise the Pavilion a1110n product by Hewlett-Packard, Palo Alto, Calif.

In accordance with a preferred embodiment of the present invention, the operator headset 114 would comprise the SP-NCHSM-776 product by Specialty Products, P.O. Box 30665, Reno, Tex. 75462.

In accordance with a preferred embodiment of the present invention, the wireless mobile router 119 would comprise the KR1 Mobile Router product by Kyocera Wireless Corp., 10300 Campus Point Dr., San Diego, Calif. 92121, and the wide area wireless network card 120 would comprise the Merlin S720 wireless card product by Sprint Wireless, 2001 Edmond Halley Dr., Reston, Va. 20191.

### Centralized Expertise Station

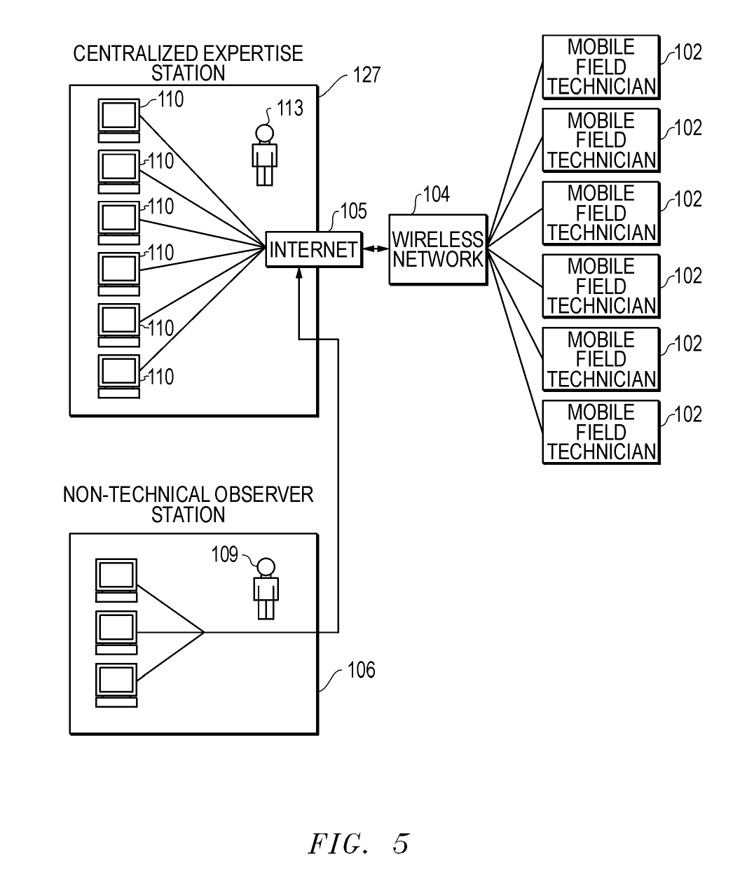

FIG. 5 shows a block diagram of a centralized expertise station 127. A centralized expertise station 127 is comprised of one or more local experts 113 and one or more local station(s) 110. The local experts 113 would guide and advise a plurality of mobile field technicians 102 via a wireless network 104 and/or the Internet 105. Alternatively, the mobile field technicians 102 need not be technicians at all but may be individuals only in need of the specialized information that the local experts 113 is providing. Accordingly, the local “expert(s)” 113 may simply be individuals with knowledge or knowledge resources sought by others. The centralized expertise station 127 could be a knowledge resource for hire that was made accessible via the wireless portable processor(s) 103, the wireless portable processor(s) and/or the wireless portable camera(s) 118.

Alternatively, the centralized expertise station 127 could be a no-fee based center for information that was made accessible via the wireless portable processor(s) 103, the wireless headset/microphone(s) 114, and/or the wireless portable camera(s) 118. Alternatively, the centralized expertise station 127 may be comprised of one or more local experts 113, who are separated by a distance and may not be in the same building or location but may be “centralized” by their function as information providers only. As used herein, “local” and “remote” are relative to logical control of the remote job site apparatus and do not necessarily denote large distance. For example, the remote job site and the local station 110 may be located in the same building or even in the same room, where it is desired to logically separate the function of the mobile field technician 102 and the local expert 113, as in a local training environment. Similarly, the mobile field technician 102 need not be physically co-located with the remote job site apparatus where it is desired to control that remote job site apparatus by means of physically distant tools and software.

In accordance with a preferred embodiment of the present invention, the centralized expertise station 127 would comprise a plurality of local experts 113, who represent a variety of trades and/or have other specialized knowledge that is sought by individuals utilizing wireless portable processors 103. An individual that uses the wireless portable processor 103 could be a maintenance employee of an apartment project and require oversight and information that would be provided by a local expert 113, which would allow the maintenance man to perform a repair or equipment installation. In accordance with a preferred embodiment of the present invention, the maintenance personnel would couple to the centralized expertise station 127 via a wireless portable processor 103, coupled to the wireless network by a wireless means 104, and the Internet 105, and receive guidance and information from a local expert(s) 113 on a fee-for-use or contract basis.

Alternatively, the local expert(s) 113 may grant permission to non-technical observer(s) 109, via a forwarded username and password access capability, to hear and see the activities of the maintenance personnel or mobile field technician(s) 102 by remotely manipulating the wireless portable camera(s) 118 pan, tilt and zoom mechanisms 141.

In accordance with an alternative embodiment of the present invention, the centralized expertise local processor 110 would comprise a two way audio/video enabled cell phone where the local expert 113 could monitor the activities and general work area of the mobile field technician 102 and manipulate the wireless remote camera(s) 118 pan, tilt and zoom mechanisms 141.

In accordance with an alternative embodiment of the present invention, the centralized expertise local processor 110 would comprise a two way audio/video enabled handheld or wearable PC where the local expert 113 could monitor the activities and general work area of the mobile field technician 102 and manipulate the wireless remote camera(s) 118 pan, tilt and zoom mechanisms 141.

Alternatively, the centralized expertise local processor 110 may be any mobile device capable of viewing the video stream and audio signal without necessarily providing the capability of manipulating the wireless remote camera(s) 118 pan, tilt and zoom mechanisms 141.

### Vehicle-Based Portable Processor

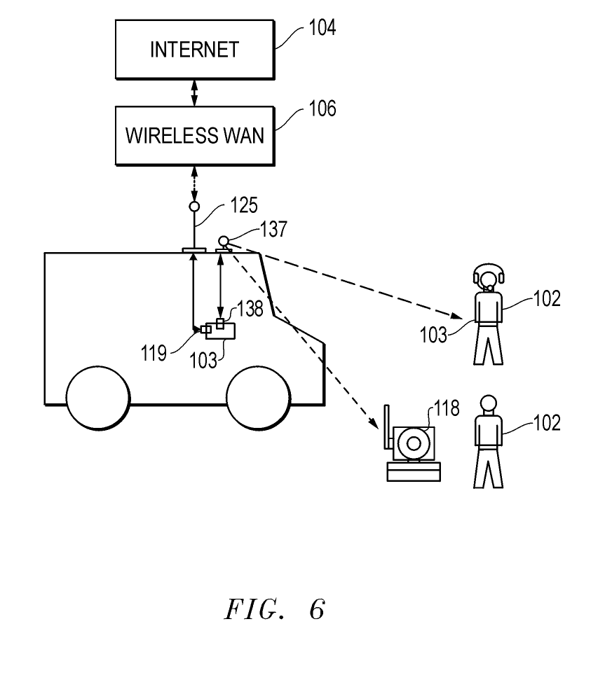

FIG. 6 shows a block diagram of a vehicle-based wireless remote system. The vehicle-based wireless remote system comprises a vehicular mounted wireless portable processor 103, a vehicular mounted wireless network antenna 125, and a vehicular mounted RF antenna 137. The mobile field technician(s) 102 would move about a job site while being remotely observed by the local expert 113 via the streamed video/audio being received by the local processor 111, and via the wireless portable camera(s) 118, which is transmitting/receiving audio and video data. In accordance with a preferred embodiment of the present invention, the wireless portable camera(s) 118 would be placed in a location to maximize observation of the mobile field technician(s) 102, would transmit/receive data via a vehicular mounted mobile wireless router 119, coupled to the Internet 105, via the WAN data card 120, and the wireless network 104, and whereby the local expert(s) 113 may observe the video and audio signals and instruct the mobile field technician(s) 102, who may grant permission to non-technical observer(s) 109, to observe the activities of the mobile field technician(s) 102 by remotely manipulating the wireless portable camera(s) 118, pan, tilt and zoom controls 141.

In accordance with an alternative embodiment of the present invention, the wireless portable processor 103 would be coupled to the Internet 105 via a direct wireless satellite uplink/downlink data connection. In accordance with an alternative embodiment of the present invention, the wireless portable camera(s) 118 and the wireless headset/microphone(s) 114 would function without the need to interact with the wireless portable processor 103, and would be wirelessly coupled to the Internet by a direct satellite uplink/downlink connection. In accordance with an alternative embodiment of the present invention, the mobile field technician(s) 102 may wear the camera(s) 118, and a headset/microphone(s) 114, and be wirelessly coupled to the vehicular mounted wireless portable processor 103 via the mobile wireless router 119, and the WAN data card 120, whereby the local expert(s) 113 may observe the video and audio signals and instruct the mobile field technician(s) 102.

In accordance with an alternative embodiment of the present invention, the vehicular mounted wireless portable processor 103 may be removed from the vehicle and be worn or carried by the mobile field technician(s) 102, and coupled by a wired or wireless connection to the wireless portable camera(s) 118, which may be worn or be located near the mobile field technician(s) 102, without requiring any further interaction with the vehicle to function. In accordance with an alternative embodiment of the present invention, the mobile field technician(s) 102 would wirelessly couple meters, telemetry devices, wearable PC's, handheld PC's, transducers or other devices both wired and wireless to the Internet 105 via the mobile wireless router 119. It would be clear to those skilled in the art that these alternative embodiments would be workable with the disclosed invention, without any undue experimentation.

### Methods of Operation

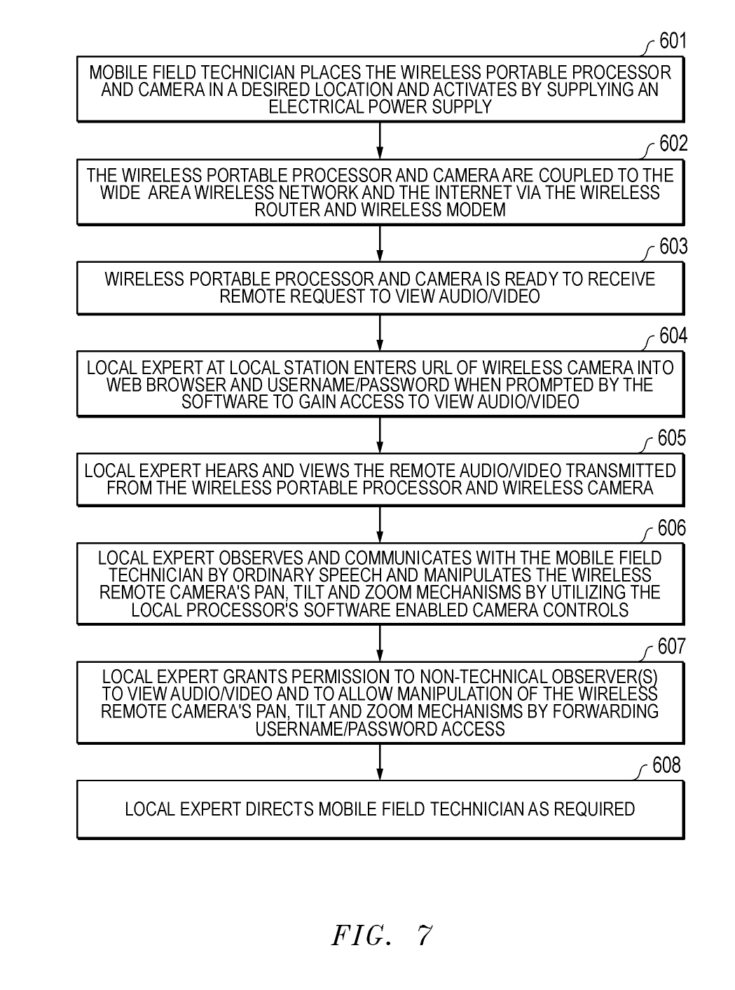

FIG. 7 shows a flow diagram of a method of operating a wireless remote system. In a step 601, the mobile field technician(s) 102 locates in an advantageous location or alternatively dons the wireless portable camera(s) 118, and provides electrical supply power to activate the wireless portable processor(s) 103.

In a step 602, the mobile field technician(s) 102 would couple the wireless portable processor(s) 103 and the wireless portable camera(s) 118 to the wireless network 104. In accordance with a preferred embodiment of the present invention, the mobile field technician(s) 102 would couple the wireless portable processor(s) 103 and the wireless portable camera(s) 118 to the CDMA wide area network and connect to the Internet 105. Alternatively, the local expert(s) 113 would initiate the connection to the wireless portable processor(s) 103 and the wireless portable camera(s) 118 by typing in the URL (Internet address) of the wireless portable camera(s) 118 into the web browser's 139 search field.

In a step 603, the wireless portable processor(s) 103 and the wireless portable camera(s) 118 transmit audio/video to the local station(s) 110 via the wireless network 104 and the Internet 105.

In a step 604, the local expert(s) 113 enters a username and password to gain access to the video/audio stream transmitted from the wireless portable processor(s) 103 and/or the wireless camera(s) 118.

In a step 605, the local expert(s) dons the operator headset(s) 112 and views the computer monitor(s) on the local processor(s) 111, and hears and views the audio/video data transmitted from the mobile field technician(s) 102 via the wireless portable processor(s) 103, the wide area wireless network 104 and the Internet 105. In accordance with a preferred embodiment of the present invention, the local expert(s) 113 would view the video data from the camera(s) 118 in on-screen video windows that can be enlarged for better detail observation and reduced in order to view multiple field technician video windows at the same time and communicate with two-way audio or by ordinary speech. In accordance with a preferred embodiment of the present invention, the local processor(s) 111 would use the D-ViewCam Management Software product by D-Link Inc., 17595 Mt. Herrmann, Fountain Valley, Calif. 92708.

In a step 606, the local expert(s) 113 manipulates the remote camera(s) 118 pan, tilt and zoom mechanisms 141 by utilizing local processor 111 located camera control software, and communicates verbally with the mobile field technician(s) 102 via ordinary speech using the local station microphone(s) 136 and the local station earphones 135 that comprise the operator headset 112.

In a step 607, the local expert(s)113 sends permission to non-technical observer(s) 109 to hear/view audio/video from the mobile field technician(s) by forwarding username and password access to the wireless remote cameras(s) 118 and to allow the non-technical observer(s) 109 to manipulate the pan, tilt and zoom mechanisms 141 of the remotely located wireless portable camera(s) 118, which are coupled wirelessly to the wireless portable processor(s) 103, the wide area network 104, and the Internet 105.

In step 608, the local expert(s) 113 observes and directs the mobile field technician(s) 113 and observes the general remote work area. Although this preferred method of operation is disclosed with regard to a technician(s) and an expert(s), collectively performing the task of troubleshooting remote apparatus, it would be clear to those skilled in the art, after perusal of this application, that there are many alternative tasks that may be performed by the mobile field technician(s) 102, with the assistance of the local expert(s) 113 and observance by the non-technical observer using substantially the same method and system. Moreover, it would be clear to those skilled in the art, after perusal of this application, how to modify the system disclosed herein, and known equipment to implement such alternative tasks without undue experimentation.

For example, the following are alternative embodiments of the invention: 1. The mobile field technician(s) 102 may not be a technician at all but is only an individual in need of information that would be provided via the wireless portable processor 103. 2. The local expert(s) 113 may not be a technician at all but may simply be an information provider via the wireless remote system. 3. The mobile field technician(s) 102 may not wear or carry the wireless portable processor 103, but would transmit audio/video to a vehicle located processor (FIG. 6) that would relay the audio/video from the wireless earphone headset 114 and the wireless camera(s) 118 to the wireless network 104 via a wireless network antenna 125. 4. The mobile field technician 102 may not wear the camera(s) 118, but would alternatively set the camera on a stationary platform in a manner so as to observe the desired area or object. The camera(s) 118 would transmit the video utilizing an attached wireless video transmitter to the wireless portable processor 103 or, alternatively, to a vehicle located processor as shown in FIG. 6. 5. The mobile field technician(s) 102 may not transmit audio/video via the wireless portable processor 103 at all, but would alternatively transmit/receive audio/video via a cell phone, a wearable PC or any handheld device embedded with a streaming video camera capability. 6. The local station(s) 110 may alternatively be a centralized expertise station(s) 127, where a plurality of local experts 113 would advise a plurality of mobile field technicians 102. The local expert(s) 113 may represent different trades or areas of expertise and may offer that expertise on a fee or contract basis. Alternatively, the local expert(s) 113 may not be technicians at all but simply information providers or allow access to information in a fee based or non-fee based environment via the wireless portable processor 103 and the wireless portable camera(s) 118. 7. The local expert(s) 113 may alternatively utilize a wireless portable processor(s) 103, with full functioning computer capability, to advise one or more mobile field technicians 102 using wireless portable processor(s) 103. The local expert(s) 113 may be at the same location or job site but find it necessary to advise one or more technicians that may be separated from each other or separated from the local expert(s) 113, or otherwise in need of instruction. An example would be a local expert(s) 113 advising mobile field technicians that are on a building roof while local expert(s) 113 may be on the first floor. 8. The non-technical observer(s) 109 may represent any person or persons who simply have an interest in the activities of the mobile field technician(s) 102, and does not imply a level of expertise in any trade or knowledge area. An example of this is where the non-technical observer(s) 109 is a homeowner who cannot be at home while a service or equipment installation is being performed there by the mobile field technician(s) 102. The local expert(s) 113 may grant permission to the home owner(s) 109 to view the video and audio data at the non-technical observer station (FIG. 4) 106 by forwarding username and password access to the non-technical observer so that they may remotely manipulate the wireless portable camera(s) 118 pan, tilt and zoom mechanism 141. 9. The local processor(s)110, 111, 107 may not be stationary computer(s) at all, but could be two way video/audio enabled cell phones and wearable or handheld PC's with the capability of viewing the remote audio/video and data streamed from the wireless portable processor(s) 103 and wireless mobile camera(s) 118. 10. The local processor(s) 110, 111, 107 may be an Internet 105 coupled television that does not necessarily have a common computer functionality but still allow the audio and video from the wireless portable processor 103 and/or the wireless portable camera(s) 118 to be seen and heard.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

1. A method for providing assistance to a plurality of mobile field operators by a local master technician, comprising the steps of:
operating a plurality of wireless remote systems wherein a wireless remote system is operated by each mobile field operator, said wireless remote system comprising an audio sensor, a video sensor, a wireless portable processor, an audio receiver and a wireless transceiver, wherein operating the wireless remote system comprises moving the audio sensor, the video sensor, the audio receiver and wireless transceiver with the mobile field operator;
operating a local station by a local master technician, said local station comprising an audio sensor, a video receiver, a processor and an audio receiver;
communicating over a wireless network between the local station and the plurality of wireless remote systems;
delivering remote sound from the audio sensor of each wireless remote system to the local station audio receiver;
delivering remote images from the video sensor of each wireless remote system to the local station monitor;
delivering local sound from the local station audio sensor to the receiver of each wireless remote system;
viewing and hearing by the local master technician of stimuli available to each mobile field operator;
communicating between the local master technician and each mobile field operator; and,
directly advising each mobile field operator by the local master technician.

2. A method for providing assistance to a plurality of mobile field operators by a plurality of local master technicians, comprising the steps of:
operating a plurality of wireless remote systems wherein a wireless remote system is operated by each mobile field operator, each wireless remote system comprising an audio sensor, a video sensor, a wireless portable processor, an audio receiver and a wireless transceiver, wherein operating the wireless remote system comprises moving the audio sensor, the video sensor, the audio receiver and wireless transceiver with the mobile field operator;
operating at least one local station by the plurality of local master technicians, the at least one local station comprising an audio sensor, a video receiver, a processor and an audio receiver;
communicating over a wireless network between the at least one local station and said plurality of wireless remote systems;
delivering remote sound from the audio sensor of each wireless remote system of said plurality to the at least one local station audio receiver;
delivering remote images from the video sensor of each wireless remote system of said plurality to the at least one local station monitor;
delivering local sound from the at least one local station audio sensor to the receiver of each wireless remote system of the plurality;
viewing and hearing by at least one local master technician of the plurality of stimuli available to each mobile field operator of said plurality;
communicating between at least one local master technician of the plurality and each mobile field operator of the plurality; and
directly advising each mobile field operator of the plurality by at least one local master technician of the plurality.

3. A method for providing remote observation of one or more mobile field operators by one or more non-technical observers, said wireless remote system comprising:
an audio sensor, a video sensor, a wireless portable processor, an audio receiver and a wireless transceiver, wherein operating the wireless remote system comprises moving the audio sensor, the video sensor, the audio receiver and wireless transceiver with the mobile field operator;
operating at least one local station by the plurality of non-technical observers, the at least one local station comprising an audio sensor, a video receiver, a processor and an audio receiver;
communicating over a wireless network between the at least one local station and the plurality of wireless remote systems;
delivering remote sound from the audio sensor of each wireless remote system of the plurality to the at least one local station audio receiver;
delivering remote images from the video sensor of each wireless remote system of the plurality to the at least one local station monitor;
delivering local sound from the at least one local station audio sensor to the receiver of each wireless remote system of the plurality;
viewing and hearing by at least one local non-technical observer of the plurality of stimuli available to each mobile field operator of said plurality;
observing between at least one local non-technical observer of the plurality and each mobile field operator of the plurality; and
directly observing each mobile field operator of the plurality by at least one local non-technical observer of the plurality.
